(19) United States
(12) Patent Application Publication
(10) Pub. No.: US 2006/0162970 A1
(43) Pub. Date: Jul. 27, 2006

(54) Method and a system for batching items into receptacles

(76) Inventors: Petur Gudjonsson, Reykjavik (IS); Magnus H Rognvaldsson, Reykjavik (IS); Brynjofur Thorsson, Reykjavik (IS)

Correspondence Address: NIXON & VANDERHYE, PC, 901 NORTH GLEBE ROAD, 11TH FLOOR, ARLINGTON, VA, 22203, US

(21) Appl. No.: 10/564,725

(22) PCT Filed: Jul. 16, 2004
(86) PCT No.: PCT/IS04/00009

§ 371 Date: Jan. 17, 2006

(30) Foreign Application Priority Data
Jul. 17, 2003 (US) 60487599
Jul. 17, 2003 (IS) 6878

(51) Int. Cl. G01G 13/04

(52) U.S. Cl. 177/121

(57) ABSTRACT

The present invention relates to a method and an apparatus for batching items (9) on non-uniform weight into batches fulfilling certain weight criteria. Items (9) are conveyed on a dynamic scale (10) registering the individual weight of items (9) and subsequently the items are combined into batches. Statistical methods are used to obtain minimum overweight or underweight in relation to the weight criterial. The invention further relates to a method and an apparatus which is capable of determining the weight of each item (9) and the weight of each batch with increased precision and minimizing the overweight or underweight of the batch.

### INTRODUCTION

The present invention relates to a method and an apparatus for batching items of non-uniform weights into batches fulfilling certain weight criteria. The items are conveyed across a scale registering the individual weights of the items and subsequently, the items are combined into batches, e.g. based on statistical methods for obtaining minimum overweight or underweight in relation to the weight criteria. In particular, the invention relates to a method and an apparatus wherein the weight of each item and the weight of the batches can be determined more precisely and wherein overweight or underweight therefore can be reduced.

### BACKGROUND OF THE INVENTION

In various industries, items are sold in batches satisfying various constraints. As an example, items of non-uniform size, shape or weight, e.g. food items such as meat, fish, fruit and vegetables, are typically handled and delivered to customers in batches having a substantially uniform size, shape and weight. Typically, the batch must fulfil requirements defined by a contract between a delivering and a receiving party and most often, minimum weight of the batches is a key issue.

Typically, batches are formed by weighing the items individually, e.g. as they are conveyed on a conveyor system across a dynamic scale. In a computer system, the items are assigned to various bins while the weights of the items are summed up in the memory of the computer system. In that way, the computer system is capable of keeping a record of the summed-up weights of all bins in the system and when a bin fulfils the requirements for a batch, it is released for further handling or packaging.

Due to the fact that dynamic scales to which the items are conveyed during the determination of their weights are more imprecise than corresponding static scales, the determined weights can differ from the actual weights of the items.

In existing systems, the weight of a specific batch is often assumed to be equal to the sum of the weights of each of the items which has entered that batch and consequently, the error in the assumed batch weight can become relatively large. In order to compensate for this inaccuracy, the delivering party often overfills the batch compared to the contractually agreed minimum weight of a batch and thus loses money. The overfilled part of the batch is often referred to as “giveaway”. Moreover, due the possible weighing error, batches may be packed in packages with underweight compared to the contractually agreed weight. Such wrongly packed packages involves increasing costs for repacking packages or, possibly, in compensating customers for underweight packages which are not found before they are shipped to the customer.

### DESCRIPTION OF THE INVENTION

It is an object of a preferred embodiment of the present invention to provide a method and a system supporting reduced giveaway in a batching process. Accordingly, the present invention, in a first aspect, relates to a method for batching items into receptacles, said method comprising:
determining an item weight by weighing the item, e.g. individually on a first scale,
determining initial weights of a plurality of receptacles by weighing the receptacles, e.g. individually on receptacle scales,
based on the determined individual weight and the receptacle weights, selecting one of the plurality of receptacles for the item thereby forming a batch,
directing the item into the selected receptacle, and
determining a resulting weight of the selected receptacle by weighing the receptacle on a corresponding receptacle scale.

Since the weight of the receptacle is determined by weighing, the error caused by summing up weights of individual items can be eliminated and the accuracy of the determining of the weight can be improved. Accordingly, the batching can be improved and the giveaway can be reduced.

Typically, the receptacles would be bins or trays wherein the items, e.g. food products such as meat or similar agricultural products, could be stored until final packing or further processing. The scales could be weighing machines for automatic capturing of an electrical signal representative of the weight of the items. The first scale could be a dynamic scale arranged along a conveyor system for capturing the weights during conveying of the items between an intake station and a plurality of receptacles arranged along the conveyor.

The receptacle scale could be a regular scale, e.g. a weighing machine such as an electronic scale integrated in each of the receptacles or arranged below the receptacles. The receptacle scales can be connected to one central processing unit or each receptacle may be connected to individual processing units capable of calculating requests for items based on the weight of the item, the weight of the receptacle and a batching method, e.g. based on a statistical algorithm.

The receptacle could be selected for items based on various statistical batching methods, e.g. considering to minimize the overweight or to ensure the minimum required weight given with a certain percentage of certainty.

During cyclic weighing and batching of items, the resulting weight of a receptacle after an item has been directed into the receptacle may be considered as the initial weight of that receptacle for the selection of a receptacle for following items until another item is directed into that receptacle or until a certain fixed time period has expired since last determining the weight of that receptacle. The fixed time period can be determined e.g. based on the stability of the weights of the items, i.e. if the weights of the items decreases over time e.g. due to dripping or evaporation of liquids from the items.

Normally, scales must be adjusted on a regular basis. Moreover, errors in a batching system may cause unwanted erroneous batching, e.g. batching with underweight or batching with overweight. If such erroneous batching is not found in time, large amounts of packed products could end up being shipped to the customer resulting in increased costs and loss. E.g. for that reason, it may be an advantage to use data combined from the first scale and the receptacle scales to automatically survey correct function and accuracy of each of the scales individually. This can be done by comparing the data received from the first scale with data received from the receptacle scales periodically, e.g. in a way to be described in the following.

A first correlation insignia can be determined based on data from the first scale and from the receptacle scales. The insignia represents a correlation between the items weight determined by the first scale and an items weight calculated as a difference between the initial weight and the resulting weight of the selected receptacle. As an example, the insignia could be defined as the items weight determined by the first scale divided by an items weight calculated as a difference between the initial weight and the resulting weight of the selected receptacle, vice versa. Alternatively, the insignia could be defined as the items weight determined by the first scale minus an items weight calculated as a difference between the initial weight and the resulting weight of the selected receptacle, vice versa.

The first correlation insignia is representative of a possible error in the system, e.g. that one scale needs adjustment or that one receptacle is misaligned in relation to discharge means of an associated conveyor system. In order to use the first correlation insignia for finding possible errors in the first scale, e.g. for finding out if adjustment of the first scale is necessary or for generating a warning signal to an operator of a batching system, at least one first correlation insignia, or an average of a plurality of first correlation insignias can be compared with a reference value, e.g. a value expressing an acceptable difference between the first scale and a receptacle scale. In order further to detect errors of the system, e.g. to detect an error of one of the receptacle scales, a first correlation insignia can be determined for a plurality of receptacles during repeated batching of a plurality of items. Subsequently, a first correlation insignia of one receptacle can be compared with a first correlation insignia of another receptacle. If one of the receptacles has a correlation insignia which is significantly different from correlation insignias of the other receptacles, it indicates a possible error in connection with that one receptacle, e.g. that the corresponding receptacle scale needs adjustment. In fact, the adjustment of the scales may be performed during repeated checking of the mutual differences between the correlation insignias or during repeated comparison of at least one of the first correlation insignias and a reference value expressing an acceptable difference between the first scale and a receptacle scale. If a significant difference occurs between the data from all of the receptacle scales and the first scale, the first scale may be adjusted based on the detected difference until the difference disappears. Reversely, if there is a significant difference between only one of the receptacle scales and the first scale or between one of the receptacle scales and the other receptacle scales, this one receptacle scale may be adjusted until the difference disappears.

A second correlation insignia representing a correlation between the weight of a receptacle and a sum of weights of items directed into the receptacle and weighed by the first scale may also be determined. The second correlation insignia may, like the first correlation insignia, represent the weight of a receptacle divided by a sum of weights of items directed into the receptacle weighed by the first scale, or vice versa, and the analysis of the second correlation insignia in order to determine faults in the system may be performed in the same manner as the analysis of the first correlation insignia. Alternatively, the second correlation insignia may represent the weight of a receptacle minus a sum of weights of items directed into the receptacle weighed by the first scale, or vice versa. The second correlation insignia is representative of the deviation between the first scale and the receptacle scales in a similar way as described above for the first correlation insignia. However, with the second correlation insignia, errors in the first scale may become more apparent due to the summing up of item weights in the receptacles. In order to perform the above mentioned adjustments of the scales, the second correlation insignia may be determined for a plurality of receptacles during repeated batching of a plurality of items. In particular, it may be interesting to perform an analysis wherein a second correlation insignia of one receptacle is compared with a second correlation insignia of another receptacle. In that comparison, it should become apparent if one of the receptacle weights is out of order and it will be possible to determine similar faults of a batching system with respect to the one receptacle having a second correlation insignia which is significantly different from other second correlation insignias of the batching system. Conversely, if all second correlation insignias are substantially equal, the actual size of the second insignia can disclose possible errors in the first scale of a batching system. As it may have become apparent for the reader, the combination of a first scale, at least one receptacle scale and the combination of data from the scales enables automatic surveillance of a batching system and, depending upon the number and types of scales used in the system, the scales may be automatically adjusted.

In order to determine if batching means of a batching system work correctly, e.g. to determine if directing arms for directing items into receptacles work correctly, the resulting weight of a receptacle, after an item has been directed into the receptacle, may be compared with the initial weight of the receptacle. If the weights are not significantly different, it may subsequently be determined if the resulting weight of any receptacle, after an item has been directed into a receptacle, is significantly different from the initial weights of the receptacles. In cases where it is found that the batching means for one receptacle of the batching system is out of order, i.e. when control commands sent from the control system to batching means for directing a particular item into a particular receptacle does not cause that item to end in that receptacle, the system may automatically exclude this particular receptacle from further selection of receptacles for items and continue to select items for the remaining receptacles.

In particular in processing and batching of food items wherein a liquid content of the food may vary in the time period which lapses between the weighing of the food item with the first scale until the food item is directed into a receptacle, a correlation between a correlation insignia of one receptacle and a distance from the first scale to the receptacle may be compared with a corresponding correlation between a correlation insignia of another receptacle and a distance from the first scale to that other receptacle. In that way, an item shrinkage measure indicating how much an item weight is reduced during the conveying of the item from the first scale to the receptacle may be calculated. As an example, the item shrinkage measure could indicate shrinkage in a number of grams for each conveyed distance or time unit.

According to one embodiment of the invention, the first scale and at least one of the receptacle scales are used for counting the items rather than, or in addition to, the weighing of the items. In that way, it can be determined whether the number of items which enter the first scale corresponds to the number of items ending in the receptacles and thus determined how many items are being misplaced, e.g. by being thrown off from the conveyor belt.

In particular in processing and batching of food items wherein a liquid content can vary, e.g. due to dripping liquid content of the item, it may be difficult to separate the part of a weighing difference between the first scale and a receptacle scale which occurs due to adjustment or accuracy problems from the part which occurs due to dripping or similar weight changes of the food item during conveying. For the purpose of calibrating the scales of a system, it may be an advantage to provide a set of items with a fixed weight. As an example, a batching system may comprise a computer system adapted to automatically adjust all scales based on the above described method of using a first scale and receptacle scales. In such a setup, scale adjustment may be improved by running a number of blocks of fixed weight through the system within various time intervals. The blocks could be made of any material which has a fixed weight over time, e.g. plastic, steel or wood.

According to a second aspect, the invention relates to a system adapted to perform batching in accordance with the described method. In particular, the invention relates to a conveyor system comprising a computer system which is adapted to receive information from a two sided scale system comprising a first scale arranged in front of a mechanism for directing the items into receptacles, e.g. bins, and at least one receptacle scale, and from the received data to calculate the first and second correlation insignias for determining malfunctioning of the system. The first scale could preferably be a dynamic scale and the receptacle scales could preferably be static scales. Since static scales are traditionally considered to be more precise than dynamic scales, the computer system could be adjusted to rely more on the static scales than on the dynamic scale, e.g. in the routine determination of the significance of the insignias. The system may be adapted to automatically generate warning signals in case of detected faults and to transmit such warning signals, e.g. via SMS (Small Message Service of a GSM network), via e-mall, via an alarm over a speaker system etc, via a flashing light etc.

Since items with a dripping liquid content, with irregular shape or with uneven weight distribution such as meat or fish products in general are difficult to weigh precisely on a dynamic scale, the invention could be useful in connection with a conveyor system made for batching food items, e.g. a conveyor system made of stainless steel and comprising scales and similar components which are durable with respect to water used for cleaning and which in general is made for hygienic handling of food items.

### DETAILED DESCRIPTION OF THE INVENTION

In the following, a preferred embodiment of the invention will be described in further details with reference to the drawing in which:

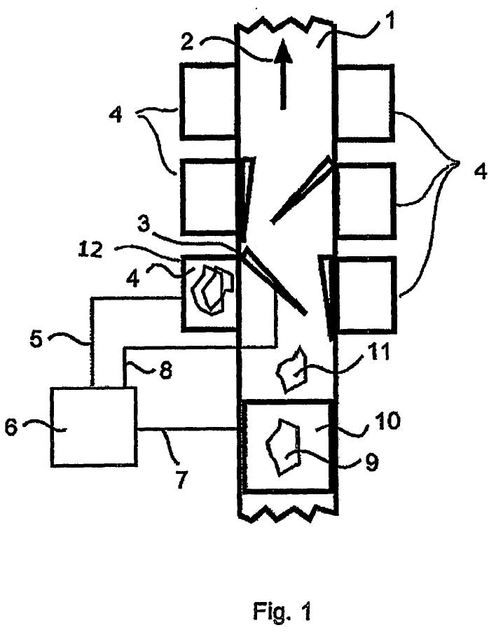

FIG. 1 shows a conveyor system with a first scale and a plurality of second scales.

FIG. 1 shows a machine for batching items wherein a second, static, scale is arranged below each receptacle. In this embodiment the item 9 is weighed on a scale 10, e.g. a dynamic scale. A weighing signal is directed to the computer system 6. Based on the weight of a particular item, previously batched items as well as the weights of the receptacles, e.g. bins 4, the particular item is directed towards a receptacle based on a batching criteria, e.g. with the objective of minimising overweight or with the objective to avoid being below a minimum weight etc.

The conveyor 1 is provided with arms 3 arranged in connection with each receptacle 4. In FIG. 1, a plurality of items 9, 11 are conveyed in a direction indicated by the arrow 2, by a conveyor belt 1. Each item is weighed and the information is stored in the memory of a computer system 6. The computer system 6 has a connection 5 to receptacle scales arranged in connection with each receptacle, and thus periodically receives information regarding the portion weights. Prior to the selecting a receptacle for a specific item, the weight of each receptacle is determined by a static scale arranged below the receptacle. After the item has been directed into a receptacle, the resulting weight of the receptacle is determined and the corresponding weight data is sent to the computer system. In other words, the actual receptacle weight is found by the use of a static scale arranged below the receptacle. In the computer system, the data coming from the static receptacle scale is compared with data coming from the dynamic scale and based on the comparison, it is evaluated if:
one of the static scales is out of order or needs readjustment,
If the dynamic scale is out of order or needs readjustment, or
If one of the arms associated with the receptacle for directing items into the receptacle works wrongly.

Assuming that no failures occur and assuming that all the receptacles are empty, the evaluation and correction could be performed in the following way:

A first item is weighed on the dynamic scale and the weight has the value w1. Subsequent to the weighing, the first item is directed into one of the receptacles, e.g. into the receptacle indicated in FIG. 1 having numeral 12. A static scale weighs this receptacle including the first item. The weight of the empty receptacle is subtracted from this weight of the receptacle (with only one item) and the result is compared to the weight of the first item found by use of the dynamic scale. If the difference is very small, no correction to the dynamic scale is necessary. In a subsequent batching process, another item is weighed with the dynamic scale and the weight has the value w2. Subsequent to the weighing, the other item is placed in the same receptacle, i.e. the receptacle having numeral 12. The computer system compares the weight of the receptacle, less the weight of the empty receptacle, with the summed value sum=w1+w2. If the difference between the weight found by the dynamic and the static scales is within a predetermined limit, no correction to the dynamic scale is made. If, on the other hand, this difference exceeds a predetermined limit, the dynamic scale is adjusted. The procedure is repeated for each item being batched or at least at certain intervals.

In another preferred embodiment, the batching may be based on filling portions up to a predetermined limit, e.g. below a target weight limit. The computer system registers frequently the receptacle weight and signals when the receptacle weight is close to the target weight limit. At this point, an appropriate item is chosen for the receptacle with the consideration of minimizing the overweight, i.e. the weight exceeding the target weight.

The computer system could be an integrated computer system comprising a central CPU or the system could be a distributed computer system wherein several individual CPUs receive information from individual scales, process the information in relation to a batching criterion for a specific receptacle and controls batching equipment to guide items into the receptacle in accordance with a batching algorithm.

The computer system is coded with a software system which, based on the received data from the scales, calculates correlation insignias indicating correlation between an items weight determined by the first scale and an items weight calculated as a difference between the initial weight and the resulting weight of the selected receptacle. The insignias could be:
W₁/W_{R},
W_{R}/W₁,
W₁-W_{R},
W_{R}-W₁,
is or any similar correlation between the values W₁ an W_{R} wherein W₁ expresses the weight determined by the first scale and W_{R} expresses the weight determined by one of the receptacle scales.

The correlation insignia is thus representative of weight difference and may for any of the receptacles be calculated for each item allocated to the receptacle or for more than one item allocated to the receptacle, e.g. for a complete batch of items in the receptacle. Furthermore, the correlation insignia may be calculated for a plurality of receptacles.

1. A method for batching items into receptacles, said method comprising:
determining an item weight by weighing the item on a first scale,
determining initial weights of a plurality of receptacles by weighing the receptacles on receptacle scales,
based on a comparison of the weight determined by weighing an item on the first scale and the initial weights of the receptacles, selecting one of the plurality of receptacles for the item thereby forming a batch,
directing the item into the selected receptacle, and
determining a resulting weight of the selected receptacle by weighing the receptacle on a corresponding receptacle scale.

2. A method according to claim 1, further comprising the step of comparing data received from the first scale with data received from at least one of the receptacle scales.

3. A method according to claim 1, further comprising the step of determining a first correlation insignia representing a correlation between the item weight determined by the first scale and an item weight calculated as a difference between the initial weight and the resulting weight of the selected receptacle.

4. A method according to claim 3, wherein at least one first correlation insignia is compared with a reference value expressing an acceptable difference between the first scale and a receptacle scale.

5. A method according to a claim 3, wherein a first correlation insignia is determined for a plurality of receptacles during repeated batching of a plurality of items, and wherein a first correlation insignia of one receptacle is compared with a first correlation insignia of another receptacle.

6. A method according to claim 5, wherein the first correlation insignias are analysed for significant differences between one of the first correlation insignias and the other first correlation insignias.

7. A method according to claim 5, wherein an average of a plurality of first correlation insignias is compared with a reference value expressing an acceptable difference between the first scale and a receptacle scale.

8. A method according to claim 3, wherein at least one of the scales is adjusted based on a first correlation insignia.

9. A method according to claim 1, further comprising determining a second correlation insignia representing a correlation between the weight of items in a receptacle found by determining the weight of the receptacle by a corresponding receptacle scale, and a sum of the weights of the items determined by the first scale.

10. A method according to claim 9, wherein a second correlation insignia is determined for a plurality of receptacles, and wherein a second correlation insignia of one receptacle is compared with a second correlation insignia of another receptacle.

11. A method according to claim 10, wherein the second correlation insignias are analysed for significant differences between one of the second correlation insignias and the other second correlation insignias.

12. A method according to claim 9, wherein at least one second correlation insignia is compared with a reference value expressing an acceptable difference between the first scale and a receptacle scale.

13. A method according to claim 10, wherein an average of a plurality of second correlation insignias is compared with a reference value expressing an acceptable difference between the first scale and a receptacle scale.

14. A method according to claim 9, wherein at least one of the scales is adjusted based on a second correlation insignia.

15. A method according to claim 1, wherein it is determined if the resulting weight of a receptacle is significantly different from the initial weight of the receptacle after an item has been directed into the receptacle.

16. A method according to claim 1, wherein it is determined if the resulting weight of any receptacle is significantly different from the initial weights of the receptacles after an item has been directed into a receptacle.

17. A method according to claim 3, wherein a correlation between a correlation insignia of one receptacle and a distance from the first scale to the receptacle is compared with a corresponding correlation between a correlation insignia of another receptacle and a distance from the first scale to that other receptacle.

18. A method according to claim 17, wherein an item shrinkage measure is calculated based on a comparison of the correlations of at least two receptacles.

19. A method according to claim 1, wherein the first scale is a dynamic scale.

20. A method according to claim 1, wherein the receptacle scales are static scales.

21. A method according to claim 1, wherein a plurality of items each having a fixed weight, is batched and wherein the scales are adjusted based on comparing data received from the first scale with data received from at least one of the receptacle scales.

22. A method according to claim 1, wherein the first scale and at least one of the receptacle scales are used for counting numbers of items passing the first scale and ending in the receptacle, respectively.

23. An integrated item batching and information handling system for producing batches of items, said system comprising:
a conveyor for conveying items across a scale,
a dynamic scale for establishing data representing weights of items conveyed on the conveyor,
means for discharging items from the conveyor,
at least one receptacle arranged along the conveyor for receiving items discharged from the conveyor, and
at least one static scale for establishing data representing weight of the at least one receptacle.

24. A system according to claim 23, further comprising a computer system connected to the first scale and at least one of the receptacle scales for comparing data received from the first scale with data received from at least one of the receptacle scales.

25. A system according to claim 23, wherein the computer system is adapted to determine a first correlation insignia representing a correlation between the item weight determined by the first scale and an item weight calculated as a difference between the initial weight and the resulting weight of the selected receptacle.

26. A system according to claim 25, wherein the computer system is adapted to compare at least one first correlation insignia with a reference value expressing an acceptable difference between the first scale and a receptacle scale and depending on the result of the comparison, to transmit a first warning signal.

27. A system according to claim 25, wherein the computer system is adapted to determine a first correlation insignia for a plurality of receptacles during repeated batching of a plurality of items, and to compare a first correlation insignia of one receptacle with a first correlation insignia of another receptacle.

28. A system according to claim 27, wherein the computer system is adapted to analyse the first correlation insignias for significant differences between one of the first correlation insignias and the other first correlation insignias.

29. A system according to claim 27, wherein the computer system is adapted to compare an average of a plurality of first correlation insignias with a reference value expressing an acceptable difference between the first scale and a receptacle scale and depending on the result of the comparison, to transmit a second warning signal.

30. A system according to claim 25, wherein the computer system is adapted to adjust at least one of the scales based on a first correlation insignia.

31. A system according to claim 24, wherein the computer system is adapted to determine a second correlation insignia representing a correlation between the weight of a receptacle determined by a corresponding receptacle scale and a sum of weights of items directed into the receptacle, the items being weighed by the first scale.

32. A system according to claim 31, wherein the computer system is adapted to determine a second correlation insignia for a plurality of receptacles, and wherein a second correlation insignia of one receptacle is compared with a second correlation insignia of another receptacle.

33. A system according to claim 32, wherein the computer system is adapted to analyze the second correlation insignias for significant differences between one of the second correlation insignias and the other second correlation insignias.

34. A system according to claim 31, wherein the computer system is adapted to compare at least one second correlation insignia with a reference value expressing an acceptable difference between the first scale and a receptacle scale.

35. A system according to claim 32, wherein the computer system is adapted to compare an average of a plurality of second correlation insignias with a reference value expressing an acceptable difference between the first scale and a receptacle scale.

36. A system according to claim 31, wherein the computer system is adapted to adjust at least one of the scales based on a second correlation insignia.

37. A system according to claim 24, wherein the computer system is adapted to determine if the resulting weight of a receptacle is significantly different from the initial weight of the receptacle after an item has been directed into the receptacle.

38. A system according to claim 37, wherein the computer system is adapted to generate a third warning signal in case the resulting weight and the initial weight is not significantly different after an item has been discharged into the receptacle.

39. A system according to claim 24, wherein the computer system is adapted to determine if the resulting weight of any receptacle is significantly different from the initial weights of the receptacles after an item has been discharged into a receptacle.

40. A system according to claim 39, wherein the computer system is adapted to generate a fourth warning signal in case the resulting weight and the initial weight is significantly different for a receptacle different from the one selected for the item.

41. A system according to claim 26, further comprising transmitting means for transmitting a warning signal to an operator of the system.

42. A system according to claim 25, wherein the computer system is adapted to compare a correlation between a correlation insignia of one receptacle and a distance from the first scale to the receptacle with a corresponding correlation between a correlation insignia of another receptacle and a distance from the first scale to that other receptacle.

43. A system according to claim 42, wherein the computer system is adapted to calculate an item shrinkage measure based on the comparison of the correlations of at least two receptacles.

44. A system according to claim 24, wherein the first scale is a dynamic scale.

45. A system according to claim 24, wherein the second scale is a static scale.

46. A system according to claim 24, wherein the computer system is an integrated computer system comprising one CPU receiving information from more than one scale.

47. A system according to claim 24, wherein the computer system comprises a plurality of CPUs connected individually to scales for obtaining weight information and information relating to a batching criterion for controlling the batching process of a corresponding receptacle individually.
